(19) United States
(12) Patent Application Publication
(10) Pub. No.: US 2010/0002323 A1
(43) Pub. Date: Jan. 7, 2010

(54) Apparatus for Viewing Front and Rear Views of an Image

(76) Inventor: Chazon Stein, Fisher Island, FL (US)

Correspondence Address: ROBERT M. SCHWARTZ, P.A., P.O. BOX 221470, HOLLYWOOD, FL, 33022, US

(21) Appl. No.: 12/061,965

(22) Filed: Jul. 3, 2008

(51) Int. Cl. G02B 27/02

(52) U.S. Cl. 359/894

(57) ABSTRACT

The present invention is an image viewing apparatus comprising a back portion having a first plane with a mirrored region viewable from the front of the apparatus, a second plane offset from the first plane, an image in the second plane, wherein the image comprises an image that is viewable from in front of the second plane and a corresponding image viewable on the mirrored region.

### BACKGROUND OF THE INVENTION

Presentation of images may take many different embodiments. Advances in photography and graphics presentations have allowed for many perspectives of visual presentations to be available. However, many presentations require complex materials and methods in order to be effective. The present invention provides for a simple apparatus whereby the front of an image in a related reverse view may be viewed simultaneously.

### BRIEF SUMMARY OF THE INVENTION

The present invention is an effective apparatus for viewing the front and related rear view of an image simultaneously.

In one embodiment, the present invention is an image viewing apparatus comprising:

(a) a back portion having a first plane with a mirrored region viewable from the front of the apparatus;

(b) a second plane, that in one embodiment may be a mounting surface, wherein the a second plane is offset from the first plane;

(c) an image in the second plane, the image may be mounted on the mounting surface;

wherein the image comprises an image that is viewable from in front of the mounting surface and a corresponding image viewable on the mirrored region.

The first plane is preferably parallel to the back of the apparatus. In one embodiment, the second plane may be parallel to the back of the apparatus. Additionally, the first and second planes may be parallel to one another.

The image has related views observable from the front of the mounting surface and the mirrored region. The image further has related views observable simultaneously from the front of the apparatus when viewed from either the left of a center plane perpendicular the second plane or the right of a center plane perpendicular the second plane. The image is a front and rear view mounted such that the front view is viewable from the front of the apparatus and the rear view is viewable in the mirrored region.

Additionally contemplated is a method for viewing multiple potions of an image comprising the steps of:

(a) providing an apparatus that has a back portion having a first plane with a mirrored region viewable from the front of the apparatus; a mounting surface in a second plane offset from the first plane; an image mounted on the mounting surface; wherein the image comprises an image that is viewable from in front of the mounting surface and an image viewable on the mirrored region.

(b) affixing an image with two opposing planer viewable portions to the mounting surface;

(c) observing the apparatus from a position in front of the apparatus from either the left of a center plane perpendicular the second plane or the right of a center plane perpendicular the second plane.

### BRIEF DESCRIPTION OF THE DRAWINGS

FIG. 1 is a front perspective view of the apparatus.

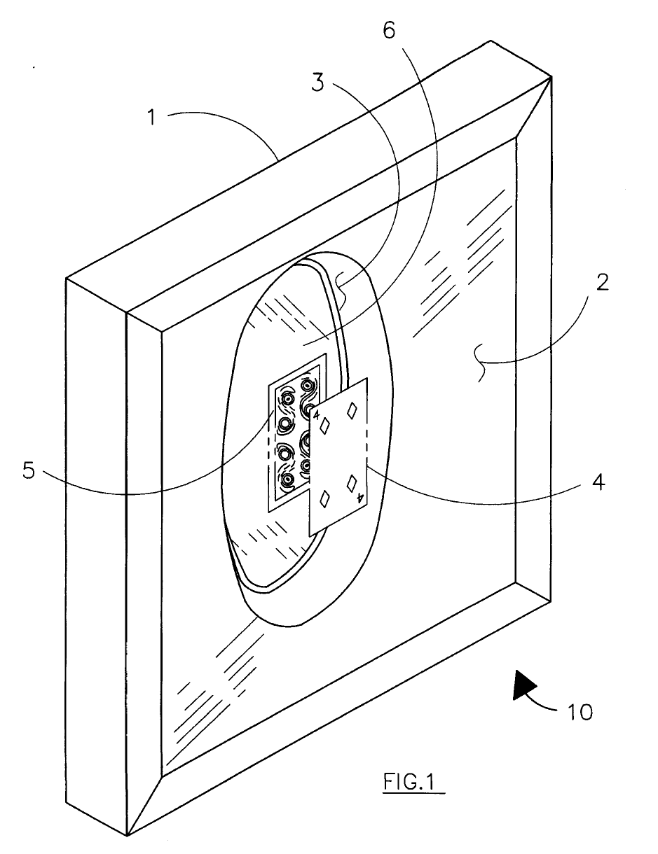

FIG. 2 is a front view of the apparatus.

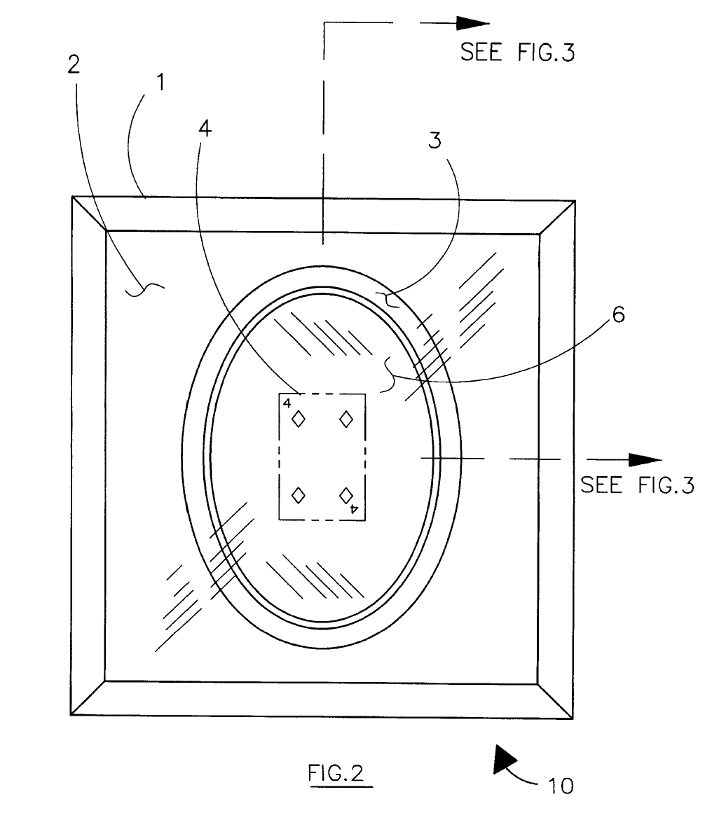

FIG. 3 is a side cross section view.

FIG. 4 shows the orientation of planes of the invention.

### DETAILED DESCRIPTION OF THE PREFERRED EMBODIMENTS

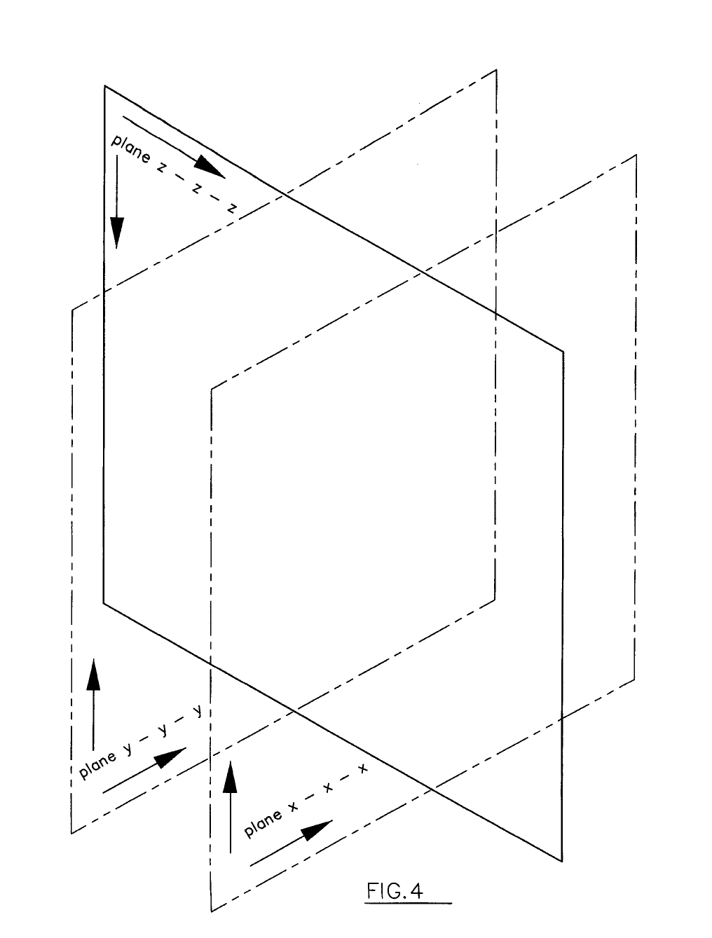

Apparatus 10 has frame 1 with mounting surface or outer glass 2, on which image 4 is placed. The mounting surface 2 may be any transparent material including but not limited to glass, plexiglass, or plastic. Cavity 3 exposes mirrored or reflective surface 6 upon which reverse image 5 of image 4 is imparted. Image 4 is in a separate horizontal plane from mirrored surface 6. As shown in FIG. 4, first plane x-x-x is placed behind second plane y-y-y. Third plane z-z-z is a perpendicular bisector of image 4. In one embodiment the first and second planes may be parallel to one another. In order to view image 4, and related reverse image 5, a viewer must not be directly in front of image 4, but must view from one side of image 4. The user should view the apparatus with both eyes positioned to the side of plane z-z-z.

Image 4 may be a photograph or any other object that has a front viewing region and corresponding image viewed on mirrored surface 5.

In one embodiment, the image may be held in position in the second plane in front of mirrored surface 6. Thus, in this embodiment, the second plane refers to orientation of the image and not a physical plane, as in a pane of glass. Image 4 may be suspended by string or wire, or may be magnetically levitated in front of mirrored surface 6.

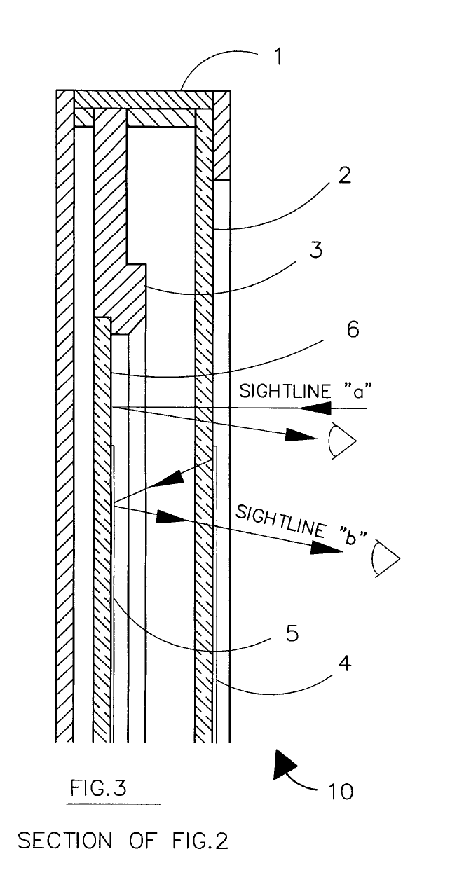

As depicted in FIG. 3, sightline “b” shows the reflection of the corresponding image 5 being viewed by a viewer on mirrored surface 6, in a particular orientation respective to the apparatus. As discussed, a user must be to one side or another of third plane z-z-z, but still must be positioned at an appropriate angle relative to image 4, corresponding image 5 and mirrored surface 6. Although the angle may vary dependent on the size of image 4 and surface 6, generally the angle may be 20°-85° offset from plane z-z-z. That is, plane z-z-z being a 90° orientation from first plane x-x-x, or second plane y-y-y. Sightline “a” demonstrates that an incorrect viewing vantage point will not allow the viewer to see corresponding image 5 on mirrored surface 6.

In another embodiment, apparatus 10 may be enclosed in glass, Lucite or other solid material such that image 4 is in a separate plane from reflective surface 6, but the separate plane is not physically defined except by the particular region in which the image resides in the solid. Image 6 may be placed in the second plane during fabrication of article 10, and the article may be finished such that image 4 is sealed into position in the second plane.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. An image viewing apparatus comprising:
(a) a back portion having a first plane with a mirrored region viewable from the front of the apparatus;
(b) a second plane offset from the first plane;
(c) a photographic image in the second plane;
wherein the photographic image comprises a front view of said image that is viewable from in front of the second plane and a corresponding rear view of said image viewable on the mirrored region.

2. The apparatus of claim 1 wherein the first plane is parallel to the back of the apparatus.

3. The apparatus of claim 1 wherein the second plane is parallel to the back of the apparatus.

4. The apparatus of claim 1 wherein the first and second planes are parallel.

5. The apparatus of claim 1 wherein the photographic image has related front and rear views observable from the front of the first plane and the mirrored region.

6. The apparatus of claim 1 wherein the photographic image has related front and rear views observable simultaneously from the front of the apparatus when viewed from either the left of a center third plane perpendicular the second plane or the right of a center third plane perpendicular the second plane.

7. The apparatus of claim 1 wherein the photographic image is a front and rear view positioned such that the front view is viewable from the front of the apparatus and the rear view is viewable in the mirrored region.

8. The apparatus of claim 1 wherein the second plane is a mounting surface.

9. The apparatus of claim 1 wherein the apparatus is contained within a frame.

10. A method for viewing multiple potions of an image comprising the steps of:
(a) providing an apparatus according to claim 1;
(b) affixing a photographic image with two opposing planer viewable portions to the mounting surface, said opposing planer viewable portions being corresponding front and rear views of said photographic image;
(c) observing the apparatus from a position in front of the apparatus from either the left of a center plane perpendicular the second plane or the right of a center plane perpendicular the second plane.
